(19) United States
(12) Patent Application Publication
(10) Pub. No.: US 2026/0184072 A1
(43) Pub. Date: Jul. 2, 2026

(54) LIQUID EJECTION HEAD, LIQUID EJECTION DEVICE, AND IMAGE FORMING APPARATUS

(71) Applicant: RISO Technologies Corporation, Tokyo (JP)

(72) Inventor: Noboru NITTA, Mishima Shizuoka (JP)

(21) Appl. No.: 19/317,076

(22) Filed: Sep. 2, 2025

(30) Foreign Application Priority Data
Dec. 26, 2024 (JP) 2024-231167

(51) Int. Cl. B41J 2/14

(52) U.S. Cl. CPC B41J 2/14233; B41J 2002/14306; B41J 2002/14419; B41J 2002/14491

(57) ABSTRACT

A liquid ejection head includes pressure chambers arranged in a first direction, each pressure chamber storing liquid, pairs of upstream and downstream flow paths, each pair communicating with a corresponding one of the pressure chambers, an upstream common chamber communicating with the upstream flow paths, an upstream port communicating with the upstream common chamber, a downstream common chamber communicating with the downstream flow paths, a downstream port communicating with the downstream common chamber, a bypass flow path connected between, and communicating with, the upstream and downstream common chambers, a bypass resistance flow path that communicates with the bypass flow path, and one or more pressure dampers including a first damper region located upstream side of the bypass resistance flow path and a second damper region located downstream side of the bypass resistance flow path.

### CROSS-REFERENCE TO RELATED APPLICATION

This application is based upon and claims the benefit of priority from Japanese Patent Application No. 2024-231167, filed on Dec. 26, 2024, the entire contents of which are incorporated herein by reference.

### FIELD

Embodiments described herein relate generally to a liquid ejection head, a liquid ejection device, and an image forming apparatus.

### BACKGROUND

A liquid ejection head that supplies a predetermined amount of liquid to a predetermined position is known. Such a liquid ejection head is mounted on, for example, an ink jet printer, a 3D printer, or a dispensing device. The ink jet printer ejects droplets of ink from an ink jet head to form an image or the like on a surface of a recording medium. The 3D printer ejects droplets of a shaping material from a shaping material ejection head and cures the droplets to form a three-dimensionally shaped object. The dispensing device ejects and supplies a predetermined amount of droplet of a sample to a plurality of containers or the like.

The liquid ejection head includes a plurality of channels for ejecting liquid. Each channel includes a nozzle that ejects liquid, a pressure chamber that communicates with the nozzle, and an actuator that changes a volume of the pressure chamber. The liquid ejection head selects one or more channels for ejecting the liquid from the plurality of channels, and applies a drive voltage to the actuator of the selected channel to eject the liquid.

In the liquid ejection head, a meniscus vibration determined by a surface tension of a meniscus of liquid in the nozzle and a mass of the liquid, remains after ejection. For example, in a high-speed liquid ejection head, it is necessary to quickly suppress the vibration, and thus resistance flow paths are provided before and after the pressure chamber. However, in a liquid circulation type head, the resistance flow path hinders circulation of the liquid. In particular, in a multi-nozzle head having a plurality of channels, if upstream and downstream ratios of the resistance flow paths do not match each other in the channels, a pressure difference occurs between the channels, and a printing quality deteriorates. That is, in a channel having a relatively small upstream flow path resistance, the ink easily wets and spreads from an edge of the meniscus to the outside of a periphery thereof, and in a channel having a relatively small downstream flow path resistance, mixing of air easily occurs, and thus it is difficult to maintain a state where the ink does not wet or spread from the edge of the meniscus to the outside of the periphery and mixing of air does not occur throughout all the channels. Thus, it is necessary to reduce a circulation flow rate, but when the circulation flow rate is small, a stirring effect for the liquid due to the circulation flow is small, and an effect of uniformizing a head temperature due to the circulation flow is also small.

In the multi-nozzle head, a total ejection flow rate of the liquid is rapidly changed by changing the number of channels ejecting the liquid at the same time. In addition, a pulsation component of a liquid circulation pump may remain in a flow rate of the liquid flowing through a liquid supply path. Therefore, it is desirable to consider a unit for alleviating a rapid change in supply pressure of the liquid ejection head due to these factors.

### BRIEF DESCRIPTION OF THE DRAWINGS

FIG. 1 is an overall configuration diagram of an ink jet printer including ink jet heads according to a first embodiment.

FIG. 2 is a perspective view of the ink jet head.

FIG. 3 is a partially enlarged cross-sectional view of a head unit of the ink jet head.

FIG. 4 is a partially enlarged cross-sectional view of the head unit.

FIGS. 5A to 5C show a partially enlarged perspective view and cross-sectional views of the head unit.

FIGS. 6A to 6C are plan views of layers of the head unit.

FIG. 7 is an overall configuration diagram of an ink circulation device of the ink jet head.

FIG. 8 shows a drive circuit of the ink jet head.

FIG. 9 shows a drive waveform applied to a piezoelectric actuator of the ink jet head.

FIGS. 10A to 10D show diagrams illustrating operations of the piezoelectric actuator to which the drive waveform is applied.

FIGS. 11A to 11C are plan views of layers of a head unit of an ink jet head according to a second embodiment.

FIG. 12 shows a modification of the ink circulation device.

FIGS. 13A to 13C are plan views of layers of a head unit of an ink jet head according to a third embodiment.

FIGS. 14A to 14C are plan views of layers of a head unit of an ink jet head according to a fourth embodiment.

FIGS. 15A to 15C are plan views of layers of a head unit of an ink jet head according to a fifth embodiment.

FIGS. 16A to 16C are plan views of layers of a head unit of an ink jet head according to a sixth embodiment.

FIGS. 17A to 17C are plan views of layers of a head unit of an ink jet head according to a seventh embodiment.

### DETAILED DESCRIPTION

A liquid ejection head of a liquid circulation type, a liquid ejection device, and an image forming apparatus capable of stably ejecting liquid are provided.

In general, according to one embodiment, a liquid ejection head comprises: a plurality of pressure chambers arranged in a first direction and respectively communicating with nozzles, each pressure chamber capable of storing liquid; a plurality of pairs of upstream and downstream flow paths, each pair communicating with a corresponding one of the pressure chambers, the upstream flow path of said each pair being connected to a first end of the corresponding pressure chamber, the downstream flow path of said each pair being connected to a second end of the corresponding pressure chamber; an upstream common chamber communicating with the upstream flow paths; an upstream port communicating with the upstream common chamber at a first end of the upstream common chamber in the first direction; a downstream common chamber communicating with the downstream flow paths; a downstream port communicating with the downstream common chamber; a bypass flow path connected between, and communicating with, the upstream common chamber at a second end of the upstream common chamber in the first direction and the downstream common chamber; a bypass resistance flow path that communicates with the bypass flow path, a cross section of the bypass resistance flow path being narrower than a cross section of the bypass flow path; and one or more pressure dampers including a first damper region located upstream side of the bypass resistance flow path and a second damper region located downstream side of the bypass resistance flow path. A circulation flow rate is greater than or equal to a maximum total ejection flow rate of the liquid ejected from the nozzles. The circulation flow rate is a flow rate at which the liquid flowing through the upstream flow paths to the downstream flow paths when a flow rate of the liquid entering from the upstream port is substantially equal to a flow rate of the liquid exiting through the downstream port as a result of small total ejection flow rate. The maximum total ejection flow rate is a flow rate at a full duty with all nozzles ejecting.

As described above, the pressure chamber extends perpendicularly to the nozzle array direction, with the second end opposite the first end. However, this is not strictly necessary. For example, the upstream flow path, the pressure chamber, and the downstream flow path can form a folded flow path (ex. WO2016111147). Alternatively, the pressure chamber can extend in the nozzle array direction (ex. JP2008-254196).

Hereinafter, liquid ejection heads according to embodiments will be described in detail with reference to the accompanying drawings. In the drawings, the same components are denoted by the same reference numerals.

### First Embodiment

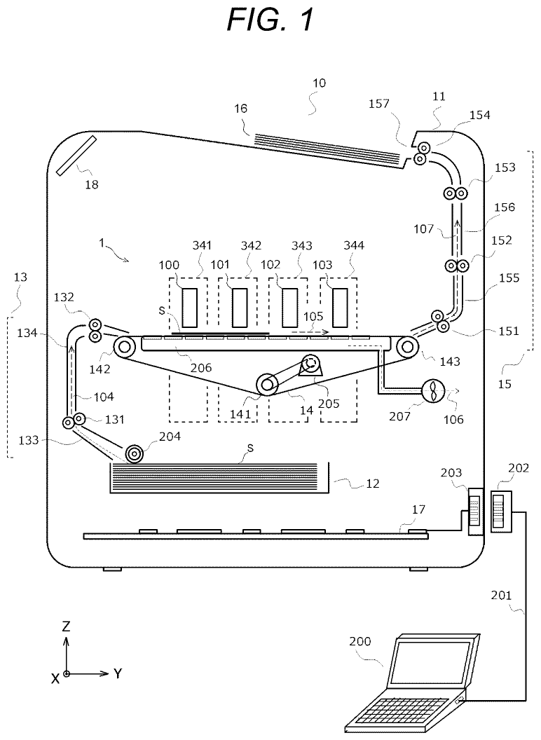

An ink jet printer 10 that prints an image on a recording medium will be described as an example of an image forming apparatus on which a liquid ejection head according to a first embodiment is mounted. FIG. 1 shows a schematic configuration of the ink jet printer 10. In the ink jet printer 10, a cassette 12 which stores a sheet S, which is a recording medium, an upstream conveyance path 13 for the sheet S, a conveyance belt 14 which conveys the sheet S taken out of the cassette 12, a plurality of ink jet heads 100 to 103 which eject droplets of ink toward the sheet S on the conveyance belt 14, a downstream conveyance path 15 for the sheet S, a discharge tray 16, and a control board 17 are disposed inside a housing 11. An operation unit 18, which is a user interface, is disposed on an upper side of the housing 11.

Image data to be printed on the sheet S is generated by, for example, a computer 200 which is an external device. The image data generated by the computer 200 is sent to the control board 17 of the ink jet printer 10 through a cable 201 and connectors 202 and 203.

A pickup roller 204 supplies the sheets S one by one from the cassette 12 to the upstream conveyance path 13. The upstream conveyance path 13 includes feed roller pairs 131 and 132 and sheet guide plates 133 and 134. The sheet S is fed to an upper surface of the conveyance belt 14 via the upstream conveyance path 13. An arrow 104 in FIG. 1 indicates a conveyance path of the sheet S from the cassette 12 to the conveyance belt 14.

The conveyance belt 14 is a mesh-shaped endless belt having a large number of through holes formed in a surface thereof. Three rollers including a drive roller 141 and driven rollers 142 and 143 rotatably support the conveyance belt 14. A motor 205 rotates the conveyance belt 14 by rotating the drive roller 141. Reference numeral 105 in FIG. 1 denotes a rotation direction of the conveyance belt 14. A negative pressure container 206 is disposed on a back surface side of the conveyance belt 14. The negative pressure container 206 is connected to a pressure reducing fan 207. The fan 207 creates a negative pressure inside the negative pressure container 206 by forming an airflow, and causes the sheet S to be adsorbed and held on the upper surface of the conveyance belt 14. Reference numeral 106 in FIG. 1 denotes a flow of the airflow.

The ink jet heads 100 to 103 as an example of the liquid ejection head are disposed so as to face the sheet S conveyed and held on the conveyance belt 14 with a slight gap of, for example, 1 mm therebetween. The ink jet heads 100 to 103 separately eject droplets of ink toward the sheet S. The ink jet heads 100 to 103 print an image when the sheet S passes therebelow. The ink jet heads 100 to 103 have the same structure except for different colors of the ink to be ejected. The colors of the ink are, for example, cyan, magenta, yellow, and black.

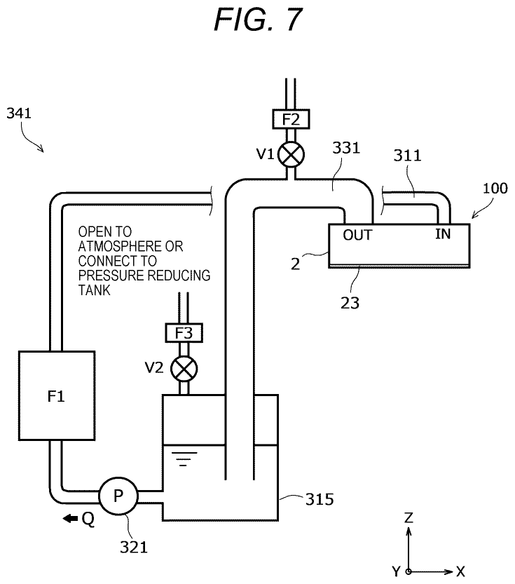

The ink is supplied to the ink jet heads 100 to 103 by respective ink circulation devices 341 to 344. A detailed configuration of the ink circulation devices 341 to 344 will be described later (see FIG. 7). In FIG. 1, for convenience of drawing, the ink circulation devices 341 to 344 are shown by respective broken line frames.

After the image formation, the sheet S is fed from the conveyance belt 14 to the downstream conveyance path 15. The downstream conveyance path 15 includes feed roller pairs 151, 152, 153, and 154 and sheet guide plates 155 and 156 that define a conveyance path for the sheet S. The sheet S is fed through a discharge port 157 to the discharge tray 16 via the downstream conveyance path 15. An arrow 107 in the drawing indicates the conveyance path for the sheet S.

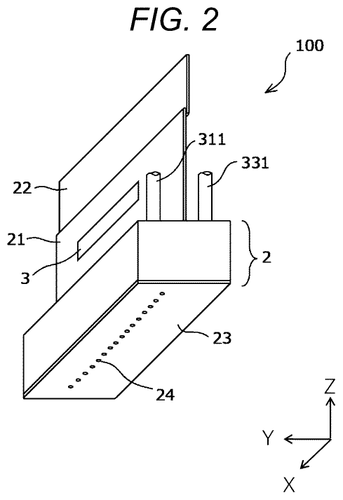

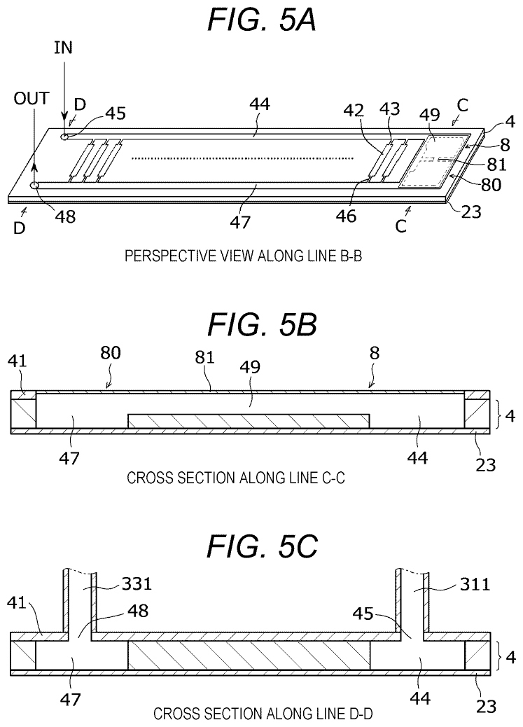

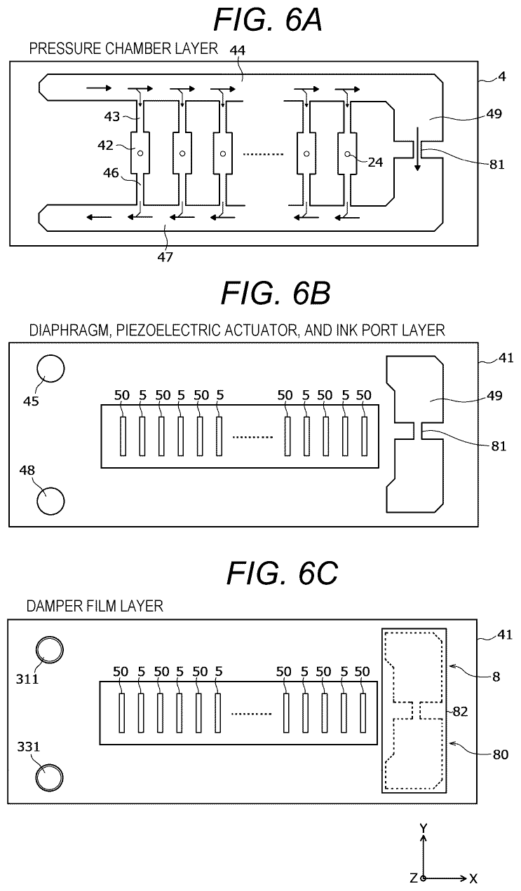

Next, a configuration of the ink jet heads 100 to 103 will be described. Hereinafter, the ink jet head 100 will be described with reference to FIGS. 2 to 6C, and the ink jet heads 101 to 103 also have the same structure as the ink jet head 100.

As shown in FIG. 2, the ink jet head 100 includes a head unit 2, which is also referred to as a liquid ejection unit. The head unit 2 is connected to a flexible printed interconnect board 21, which is also referred to as a film interconnect board. The flexible printed interconnect board 21 is connected to a printed board 22, which is also referred to as a relay board. The head unit 2 includes a nozzle plate 23. The ink circulation type head unit 2 is connected to the ink circulation device 341 via an ink supply path 311 and an ink discharge path 331.

Nozzles 24 of respective channels that eject ink are arranged along a first direction of the nozzle plate 23, for example, an X direction. A nozzle density is set within a range of, for example, 150 dpi to 1,200 dpi. The nozzles 24 are not limited to being arranged in one row, but may be arranged in a plurality of rows. A detailed configuration of the head unit 2 will be described later.

The flexible printed interconnect board 21 has a synthetic resin film such as a polyimide. A drive integrated circuit (IC) 3 (hereinafter, referred to as a drive IC or a drive chip) is mounted on the flexible printed interconnect board 21. The printed board 22 is a hard through-hole board in which an epoxy resin layer containing glass fibers and a copper interconnect layer are laminated in multiple layers. The drive IC 3 serving as a control unit of the ink jet head 100 temporarily stores print data transmitted from the control board 17, including a central processing unit (CPU) serving as a control unit of the ink jet printer 10, via the printed board 22, and applies a drive signal to each channel so as to eject ink at a predetermined timing.

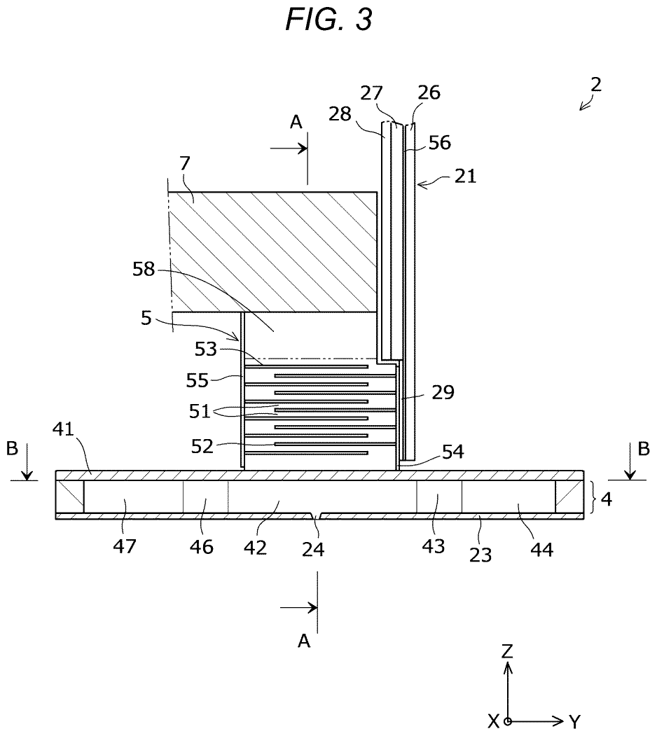

FIGS. 3 to 6C are partial cross-sectional views of the head unit 2. The nozzle plate 23 is bonded to one surface of a pressure chamber board 4. The nozzle plate 23 is a rectangular plate formed of resin such as polyimide or metal such as stainless steel. A diaphragm 41 is bonded to one surface of the pressure chamber board 4 on a side opposite to the nozzle plate 23. The diaphragm 41 has flexibility to be deformed when an external force is applied. The diaphragm 41 is a rectangular plate formed of, for example, a flexible polyimide film or metal.

A pressure chamber 42 is formed in the pressure chamber board 4. A plurality of pressure chambers 42 are arranged at positions of the respective nozzles 24 and separately communicate with the nozzles 24. The pressure chamber 42 is formed in a groove shape along a second direction, for example, a Y direction. The pressure chamber 42 is formed by, for example, forming a rectangular opening penetrating a third direction, for example, a Z direction, in the pressure chamber board 4 and closing openings on both sides in the Z direction with the nozzle plate 23 and the diaphragm 41, thereby forming a space to be filled with ink.

In the ink circulation type head, upstream ends of the pressure chambers 42 in the Y direction communicate with an upstream common liquid chamber 44 via respective upstream resistance flow paths 43. The upstream common liquid chamber 44 is formed so as to extend in an arrangement direction of the pressure chambers 42 (i.e., X direction) while connecting the upstream resistance flow paths 43 in order to a side surface side thereof. The upstream common liquid chamber 44 is an ink supply manifold that supplies ink to the pressure chambers 42 via the upstream resistance flow paths 43. The upstream common liquid chamber 44 is formed by, for example, forming an opening penetrating, for example, the Z direction, in the pressure chamber board 4 and closing openings on both sides in the Z direction with the nozzle plate 23 and the diaphragm 41, thereby forming a space through which ink flows. An upstream ink port 45 that supplies ink to the upstream common liquid chamber 44 is provided on one side in the arrangement direction of the plurality of pressure chambers 42, that is, on one end side in the X direction in the shown example. The upstream ink port 45 is connected to the ink supply path 311 (see FIG. 2). The upstream ink port 45 is an example of an upstream liquid port.

The other ends (i.e., the downstream ends) of the pressure chambers 42 in the Y direction communicate with a downstream common liquid chamber 47 via downstream resistance flow paths 46. The downstream common liquid chamber 47 is formed so as to extend in the arrangement direction of the pressure chambers 42 (i.e., X direction) while connecting the downstream resistance flow paths 46 in order to a side surface side thereof. The downstream common liquid chamber 47 is an ink discharge manifold through which the ink discharged from the pressure chambers 42 via the downstream resistance flow paths 46 flows in common. The downstream common liquid chamber 47 is formed by, for example, forming an opening penetrating, for example, the Z direction, in the pressure chamber board 4 and closing openings on both sides in the Z direction with the nozzle plate 23 and the diaphragm 41, thereby forming a space through which ink flows. A downstream ink port 48 that discharges the ink from the downstream common liquid chamber 47 to the outside of the head unit 2 is provided on the same end side in the X direction as the upstream ink port 45. The downstream ink port 48 is connected to the ink discharge path 331 (see FIG. 2). The downstream ink port 48 is an example of a downstream liquid port.

The upstream resistance flow path 43 is formed, for example, to be narrower than a width of the pressure chamber 42 in the X direction, thereby reducing a flow path cross section and having a flow path resistance. Similarly, the downstream resistance flow path 46 is formed, for example, to be narrower than the width of the pressure chamber 42 in the X direction, thereby reducing a flow path cross section and having a flow path resistance. In the ink circulation type head, the upstream resistance flow path 43, the pressure chamber 42, and the downstream resistance flow path 46 form a pressure chamber circulation flow path.

In order to reduce the flow path cross sections of the upstream resistance flow path 43 and the downstream resistance flow path 46, the upstream resistance flow path 43 and the downstream resistance flow path 46 may each be narrower than a width in the Z direction, or be narrower than both the widths in the X direction and the Z direction, instead of being narrower than the width in the X direction. The upstream resistance flow path 43 and the downstream resistance flow path 46 are each preferably formed along a center axis of the pressure chamber 42 in the Y direction, but are not limited thereto. That is, in the upstream resistance flow path 43 and the downstream resistance flow path 46, it is sufficient that the flow path cross section for the ink is smaller than a flow path cross section of the pressure chamber 42. Therefore, shapes of the flow path cross sections of the upstream resistance flow path 43 and the downstream resistance flow path 46 are not limited to a rectangle. It is preferable that the upstream resistance flow paths 43 have the same shape in the channels, but are not limited thereto. It is preferable that the downstream resistance flow paths 46 also have the same shape in the channels, but are not limited thereto. The upstream resistance flow path 43 and the downstream resistance flow path 46 are each preferably symmetrical in the Y direction via the pressure chamber 42, but are not limited thereto. However, in order to prevent an occurrence of a pressure difference between the channels, the resistance flow paths (43, 46) in the channels are formed so as to have the same upstream and downstream resistance ratio.

A bypass flow path 49 is provided on one side in the arrangement direction of the plurality of pressure chambers 42, that is, on the other end side in the X direction in the shown example. That is, it is disposed on a side opposite to the upstream ink port 45 and the downstream ink port 48. The bypass flow path 49 is a flow path that connects the other ends of the upstream common liquid chamber 44 and the downstream common liquid chamber 47 to bypass the ink.

That is, the upstream common liquid chamber 44 branches into and is connected to the upstream resistance flow paths 43 in order toward the other end side in the arrangement direction of the pressure chambers 42, and is connected to one end of the bypass flow path 49 at a position beyond the last upstream resistance flow path 43. The downstream common liquid chamber 47 is connected to the other end of the bypass flow path 49, merges with and is connected to the downstream resistance flow paths 46 in order toward one end side in the arrangement direction of the pressure chambers 42, and is connected to the downstream ink port 48 at a position beyond the last downstream resistance flow path 46.

For example, the bypass flow path 49 has a flat shape in which a width in the Z direction is small and a width in the X direction is large such that a damper effect of a pressure damper (8, 80) to be described later is easily obtained. A bypass resistance flow path 81 is provided in the middle of the bypass flow path 49. The bypass resistance flow path 81 is formed, for example, to be narrower than the width of the bypass flow path 49 in the X direction, thereby reducing a flow path cross section and having a flow path resistance. Accordingly, a circulation flow of the ink can be formed not only in the bypass flow path 49 but also in a pressure chamber circulation flow to be a flow for supplying the ink into the pressure chambers 42. A ratio of a flow rate of the ink flowing through the bypass flow path 49 to a total flow rate of the ink of the pressure chamber circulation flow flowing through the pressure chambers 42 can be adjusted based on a dimension (i.e., a flow path cross section area and a flow path length) of the bypass resistance flow path 81. For example, if a flow path resistance of the bypass flow path 49 is reduced by increasing a flow path cross-sectional area of the bypass resistance flow path 81, more ink flows through the bypass flow path 49, and if the flow path resistance of the bypass flow path 49 is increased by decreasing the flow path cross-sectional area of the bypass resistance flow path 81, more ink flows through the pressure chambers 42 relatively. At this time, the flow rate of the ink flowing through the pressure chambers 42 is adjusted to be smaller than a flow rate of the ink ejected from the nozzles 24. Preferably, the flow rate of the ink supplied into the pressure chambers 42 is, for example, 0.6 times the flow rate of the ink ejected from the nozzles 24. A shortage is drawn from the downstream common liquid chamber 47 as described later.

In order to compensate for the shortage from the downstream common liquid chamber 47, a total flow rate of the ink flowing through the bypass flow path 49 and the ink flowing through flow paths of the channels from inlets of the upstream resistance flow paths 43 to outlets of the downstream resistance flow paths 46 is set to be equal to or greater than a total maximum ejection flow rate of the ink ejected from the nozzles 24. This flow rate setting is performed by, for example, the ink circulation device 341. The maximum ink ejection flow rate is a total flow rate when the ink is ejected from all the ejection channels. A circulation flow rate of the ink is greater than or equal to a maximum total ejection flow rate of the liquid ejected from the nozzles. The circulation flow rate is the flow rate through the upstream and downstream flow paths under a condition where the flow rate of liquid entering from the upstream ink port 45 can be considered substantially equal to the flow rate of liquid exiting through the downstream ink port 48. The maximum total ejection flow rate is a flow rate at a full duty with all nozzles ejecting. The state “a flow rate of the liquid being ejected is low enough” is defined as the state in which “the circulation flow rate is the flow rate through the upstream and downstream flow paths under a condition where the flow rate of liquid entering from the upstream ink port 45 can be considered substantially equal to the flow rate of liquid exiting through the downstream ink port 48.”

For example, when a circulation flow rate of the ink flowing through the pressure chambers 42 is set to 0.6 times the ejection flow rate as described above, the flow path resistance of the bypass flow path 49 is set to (6/14) times a parallel resistance of flow path resistances of all the flow paths passing through the pressure chamber 42 such that 1.4 times the ejection flow rate flows through the bypass flow path 49. This setting is performed, for example, by adjusting the dimension (i.e., the flow path cross section area and the flow path length) of the bypass resistance flow path 81. Then, if the ink is circulated from the upstream ink port 45 toward the downstream ink port 48 at, for example, twice the total maximum ejection flow rate, the circulation flow rate while the ink is not ejected is in a ratio of 3:7 between a circulation path passing through the pressure chambers 42 and the bypass flow path 49. At the maximum ejection flow rate, the ink flows backward from the downstream common liquid chamber 47 toward the pressure chamber 42, but since a corresponding amount of ink is supplied from the bypass flow path 49 to the downstream common liquid chamber 47, the ink does not flow backward from the downstream ahead of the downstream ink port 48 which may be contaminated with foreign matter or air bubbles.

A relationship between the flow rate of the circulation flow of the ink flowing through the pressure chambers 42, that is, the flow rate of the ink flowing through the pressure chambers 42 when the ink is not ejected from the nozzles 24, and a flow rate of the circulation flow of the ink flowing through the bypass flow path 49 is, for example, the following relationships a) to d), with the maximum ejection flow rate, that is, a total consumption amount of the ink when maximum continuous ejection is performed from all the nozzles 24 being 1.

| | Pressure | | | |
|---|---|---|---|---|
| | chamber 42 | Bypass flow path 49 | Total | Ratio |
| a) | 0.6 | 0.4 | 1 | 6:4 |
| b) | 0.6 | 1.4 | 2 | 3:7 |
| c) | 0.2 | 0.8 | 1 | 1:4 |
| d) | 0.2 | 1.8 | 2 | 1:9 |

Since the total flow rates of b) and d) are larger than those of a) and c), b) and d) are advantageous in stabilizing a temperature and preventing sedimentation of ink components. Since the total flow rates of a) and c) are smaller than those of b) and d), the ink supply in a) and c) is easier. Since the circulation flow rates in the pressure chamber of c) and d) are smaller than those of a) and b), an influence of the flow path resistance on a nozzle back pressure in c) and d) is smaller, and the nozzle back pressure is stabilized more easily. Since the circulation flow rates of the pressure chamber of a) and b) are larger than those of c) and d), it is easy for the pressure chamber of a) and b) to discharge foreign matter or air bubbles mixed in the pressure chamber 42 toward downstream. Since the ratio of the flow rate of the bypass flow path 49 to the circulation flow rate of the pressure chamber is larger in the order of d), c), b), and a), even when a needle-shaped foreign matter or the like is mixed in the supplied ink, it is difficult to mix the needle-shaped foreign matter or the like into the pressure chambers 42. In all of a), b), c), and d), since the total flow rate exceeds 1, it is possible to prevent the foreign matter in the ink from being drawn into the head unit 2 from the downstream ink port 48 even at the maximum ejection flow rate. As listed in the left column of the table, the circulation flow rate of the pressure chamber 42 is less than 1 for all cases a), b), c), and d). For example, the circulation flow rate of the pressure chamber 42 is 0.6 for a) and b), and 0.2 for c) and d). Therefore, the influence of flow path resistance on nozzle back pressure is small, and ink supply is easier. However, care must be taken to prevent foreign matter from being drawn in from the downstream side.

A pressure damper that suppresses a rapid change in pressure is provided in an ink circulation system path. The pressure damper includes an upstream pressure damper 8 disposed upstream of the bypass resistance flow path 81 and a downstream pressure damper 80 disposed downstream of the bypass resistance flow path 81. In the present embodiment, the bypass resistance flow path 81 is disposed at a center of the bypass flow path 49, and both the upstream pressure damper 8 and the downstream pressure damper 80 are provided in the bypass flow path 49. The upstream pressure damper 8 and the downstream pressure damper 80 have the same basic structure. That is, the upstream pressure damper 8 and the downstream pressure damper 80 are each formed by opening one surface of the bypass flow path 49 opposite to the nozzle plate 23 in the Z direction and sealing the opening with a soft material 82 such as a thin polyimide film. The soft material 82 is also referred to as a damper film. The soft material 82 such as a polyimide film is an example of a flexible resin that covers an opening portion of the bypass flow path 49. Both the upstream pressure damper 8 and the downstream pressure damper 80 are, for example, membrane dampers. In the upstream pressure damper 8 and the downstream pressure damper 80, when an ejection amount of the ink is rapidly changed, the soft material 82, which is a damper film, is bent, and a rapid pressure change in the upstream common liquid chamber 44 and the downstream common liquid chamber 47 can be alleviated.

That is, in particular, in a multi-nozzle head having a plurality of channels for ejecting ink, a flow rate of the ejected ink may rapidly change depending on a print content. For example, when a line drawing pattern with many blanks is to be printed continuously after a state where all channels perform printing at a full duty, the flow rate of the ink rapidly decreases, and conversely, for a pattern in which printing at a full duty after a blank, the flow rate of the ink rapidly increases. When there is such a sudden change in flow rate of the ink, the ink having a mass needs to be suddenly stopped or suddenly started, and thus a back pressure of the ink to be ejected changes. The change in back pressure influences a behavior of the ink to be ejected, and causes deterioration in printing quality.

Although the pressure damper may be provided as a unit for absorbing the change in back pressure of the ink, it is difficult to provide the pressure damper with a simple configuration since the ink circulation type ink jet head 100 has many flow paths. When the upstream pressure damper 8 and the downstream pressure damper 80 are provided in the bypass flow path 49 as in the present embodiment, the damper effect can be applied to both the upstream common liquid chamber 44 and the downstream common liquid chamber 47. This method allows a damper to be easily installed with a simple configuration. When the pressure damper is provided only upstream of the bypass resistance flow path 81, the upstream pressure damper acts downstream via the bypass resistance flow path 81, and thus the damper effect is weakened.

Further, when the upstream pressure damper 8 and the downstream pressure damper 80 are provided in the bypass flow path 49 as in the present embodiment, there is also an advantage that one soft material 82 can be shared by both the upstream pressure damper 8 and the downstream pressure damper 80. In addition, since the upstream pressure damper 8 and the downstream pressure damper 80 are provided in the bypass flow path 49, it is also advantageous for easy filling with the ink. A membrane type pressure damper functions more efficiently as it is thinner and has a larger area. Therefore, the bypass flow path 49 is preferably made into a flatter shape by adjusting the widths in the Z direction and the X direction, so that an area of the soft material 82, which is a damper film, is increased. However, a location where the soft material 82 is disposed is not necessarily limited to the opening in the Z direction.

When the pressure damper 8 is provided in the bypass flow path 49, the flow rate of the ink flowing through the bypass flow path 49 is preferably, for example, equal to or greater than a total circulation flow rate of the ink flowing through the pressure chambers 42. That is, in order to cause the pressure damper 8 to effectively function, a dimension (i.e., a flow path cross-sectional area and a flow path length) of the bypass resistance flow path 81 is designed such that the flow path resistance of the bypass flow path 49 is equal to or less than a parallel flow path resistance of all flow paths passing through the pressure chambers 42. The flow path resistance of all the flow paths passing through the pressure chambers 42 is flow path resistances of a plurality of flow paths from the inlets of the upstream resistance flow paths 43 to the outlets of the downstream resistance flow paths 46. The parallel flow path resistance is an inverse of a total of inverse numbers of the flow path resistances of all the channels.

However, the cross section of the bypass flow path 49 is not limited to a flat shape, and the width in the Z direction and the width in the X direction may be adjusted. The shape of the flow path cross section of the bypass flow path 49 is not limited to a rectangle.

FIG. 7 shows an overall configuration of the ink circulation device 341 that circulates and supplies ink to the ink jet head 100. The ink circulation device 341 is a liquid circulation device in a liquid ejection head. The ink circulation devices 342 to 344 that circulate and supply ink to the ink jet heads 101 to 103 has the same configuration as the ink circulation device 341. As shown in FIG. 7, the ink circulation device 341 includes an ink tank 315, an ink pump 321, an ink filter F1, the head unit 2 of the ink jet head 100, and the ink supply path 311 and the ink discharge path 331 that connect these components. Further, the ink supply path 311 and the ink discharge path 331 are provided with air valves V1 and V2 and air filters F2 and F3, respectively. The ink level in ink tank 315 is maintained at a constant level by an ink replenishment unit (not shown).

The ink entering the upstream common liquid chamber 44 is controlled to a predetermined flow rate by the pump 321, while the ink leaving the downstream common liquid chamber 47 is controlled to a predetermined pressure determined by the liquid level in the tank 315 and the height difference of the nozzle plate 23. Therefore, the downstream ink discharge path 331 is preferably thicker than the ink supply path 311. The ink supply path 311 is, for example, a tube having a diameter of 3 mm, and the ink discharge path 331 is, for example, a tube having a diameter of 6 mm. In this case, an opening of the upstream ink port 45 has a diameter of 3 mm, and an opening of the downstream ink port 48 has a diameter of 6 mm.

During initial filling with the ink, the ink circulation device 341 first closes the air valve V2 and opens on the air valve V1 to supply the ink from upstream by the ink pump 321. The ink flows into the head unit 2 via the upstream ink port 45, and flows through the upstream common liquid chamber 44. Then, the ink flows into the downstream common liquid chamber 47 via the pressure chambers 42 in the channels and the bypass flow path 49. The ink discharged from the downstream common liquid chamber 47 to the outside of the head fills the ink discharge channel 331. When the ink in the ink discharge channel 331 is filled to the point where it reaches valve V1, valve V1 is closed, and then valve V2 is opened. While the pump 321 is operating in this state, the ink circulates through the tank 315, pump 321, filter F1, ink supply channel 311, head 2, ink discharge channel 331, and tank 315 in this order.

Steady circulation is performed at a constant flow rate. At this time, since the ink flowing in from the ink supply path 311 is the ink that has passed through the filter F1, the ink has less foreign matter and is cleaner than the ink in the ink discharge path 331. Since the ink in the ink discharge path 331 is farther from the ink pump 321 than the ink in the ink supply path 311 and the pressure is stabilized in the ink tank 315, the ink in the ink discharge path 331 is hardly influenced by a pulsation of the ink pump 321 and the pressure is stabilized. The flow rate of the ink flowing through the upstream common liquid chamber 44, the flow rate of the ink flowing through the pressure chambers 42 in the channels, and the flow rate of the ink flowing through the bypass flow path 49 are set as described above. An ejection operation of the ink in the channels is performed in a state where the ink circulation flow is maintained.

Returning to the description of FIG. 3, a piezoelectric actuator 5, which is simply referred to as an actuator, is disposed on one surface of the diaphragm 41 on a side opposite to the pressure chamber 42. The piezoelectric actuators 5 in the channels are arranged at positions facing the pressure chambers 42 with the diaphragm 41 interposed therebetween. The piezoelectric actuator 5 is disposed such that a center axis is located on a center axis of the pressure chamber 42. The piezoelectric actuator 5 and the diaphragm 41 are bonded to each other by, for example, an adhesive. The piezoelectric actuator 5 is fixed by bonding, to a support member 7, one surface thereof opposite to the diaphragm 41 in the Z direction. In particular, as shown in FIG. 3, the piezoelectric actuator 5 is a laminated piezoelectric actuator formed by alternately laminating a piezoelectric body 51 such as a piezoelectric element, a first internal electrode 52, and a second internal electrode 53 in layers. The piezoelectric bodies 51 are disposed such that polarization directions are opposite to each other in, for example, the Z direction, and are deformed in a d33 mode. The first internal electrode 52 and the second internal electrode 53 are conductive films formed on main surfaces of the piezoelectric body 51. The first internal electrode 52 is formed up to one end surface of the piezoelectric actuator 5 in the Y direction, and is connected to a first external electrode 54 formed on the one end surface. The second internal electrode 53 is formed up to the other end surface of the piezoelectric actuator 5 in the Y direction, and is connected to a second external electrode 55 formed on the other end surface.

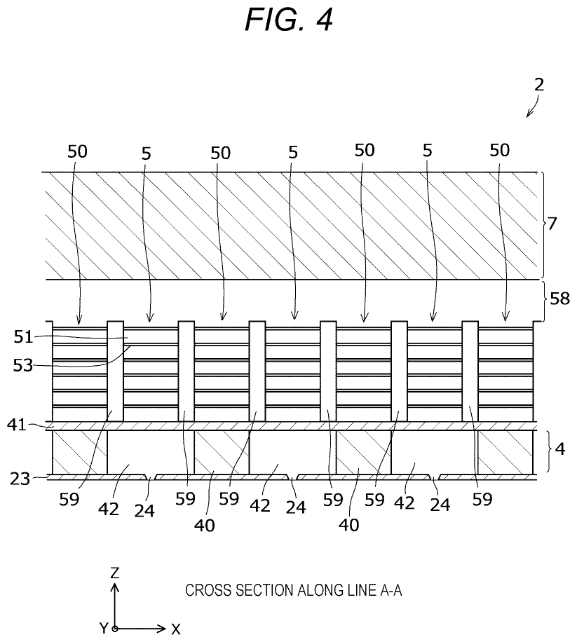

A dummy layer 58 is made of the same material as the piezoelectric body 51. The dummy layer 58 is not provided with an internal electrode and is not deformed since an electric field is not applied thereto. The dummy layer 58 serves as a base for fixing the piezoelectric actuator 5 to the support member 7 (see FIG. 4), or serves as a polishing allowance for polishing to improve accuracy during and after assembly. In particular, as shown in FIG. 4, pillars 50 may be disposed between the piezoelectric actuators 5 in the channels via grooves 59. The pillar 50 may be a dummy actuator formed in the same manner as the driving piezoelectric actuator 5. The pillar 50 is disposed at, for example, a position corresponding to a partition wall 40 between adjacent pressure chambers 42. The internal electrodes 52 and 53 between the pillars 50 are not connected to a drive circuit of the drive IC 3 to be described later, that is, are not driven, and thus serve as fixed portions that are not deformed. The pillar 50 may be formed of another member instead of the dummy actuator.

In the case of the piezoelectric actuator 5 in which the plurality of piezoelectric bodies 51 are laminated, for example, the first internal electrode 52 and the second internal electrode 53 are formed on main surfaces of the piezoelectric bodies 51 processed into a thin plate shape. Then, the piezoelectric bodies 51 are laminated and fired, integrating them with each other. Thereafter, the first external electrode 54 and the second external electrode 55 are formed. Thereafter, the piezoelectric body 51 is polarized by a polarization voltage. The piezoelectric body 51 is formed of a lead-containing piezoelectric material such as lead zirconate titanate (PZT) or a lead-free piezoelectric material such as potassium sodium niobate. The first internal electrode 52 and the second internal electrode 53 are formed of a conductive material that can be fired, such as silver palladium. The first external electrode 54 and the second external electrode 55 are formed of Ni, Cr, Au, or the like by a known method such as plating or sputtering.

The first external electrodes 54 in the channels are connected to an individual interconnect 56 of the flexible printed interconnect board 21 (see FIG. 3). The flexible printed interconnect board 21 includes a substrate 26, the individual interconnect 56, an adhesive layer 27, and an insulating layer 28. The flexible printed interconnect board 21 is disposed such that a region where a solder plating layer 29 is formed faces the first external electrode 54, and the first external electrodes 54 in the channels and the individual interconnect 56 are electrically and mechanically connected to each other by melting a solder. Instead of the solder, the first external electrodes 54 in the channels and the individual interconnects 56 are fixed to each other by an anisotropic conductive film (ACF), an anisotropic conductive paste (ACP), a non-conductive film (NCF), a non-conductive paste (NCP), or the like, and are anisotropically connected in a thickness direction. On the other hand, the second external electrodes 55 in the channels are connected to a common interconnect (not shown) and are connected to a ground (GND) via, for example, the flexible printed interconnect board 21.

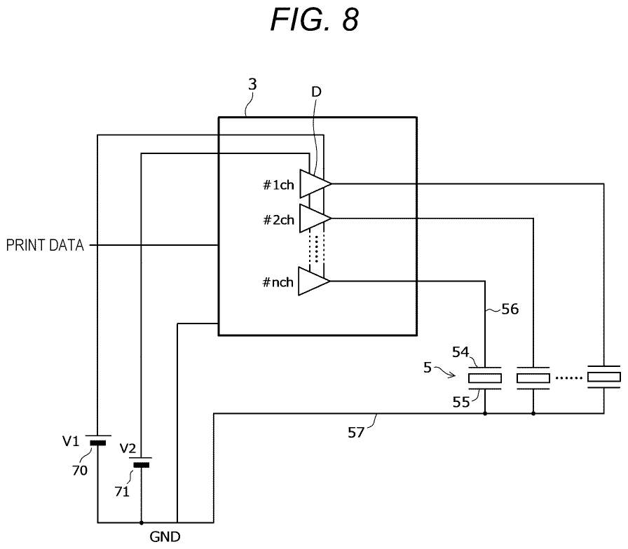

FIG. 8 shows an example of the drive circuit of the ink jet head 100. As shown in FIG. 8, the first external electrode 54 of the piezoelectric actuator 5 in each of channels (#1 ch to #n ch) is connected to the individual interconnect 56, and is connected to an output terminal of a drive driver D (that is, the drive circuit) of the drive IC 3. A connection point between the first external electrode 54 and the individual interconnect 56 is an individual terminal of the piezoelectric actuator 5. The second external electrode 55 is connected to a common interconnect 57, and is connected to a common potential. A connection point between the second external electrode 55 and the common interconnect 57 is a common terminal of the piezoelectric actuator 5.

The drive IC 3 is connected to a power supply 70 for applying a drive voltage V1 and a power supply 71 for applying a drive voltage V2 to the piezoelectric actuator 5 during ink ejection. The power supply 70 and the power supply 71 have positive electrodes connected to the drive IC 3 and negative electrodes connected to the ground (GND). The drive IC 3 is connected to a signal line of the print data transmitted from the control board 17 (see FIG. 1), which is a control unit of the ink jet printer 10. The print data is transmitted as a control signal via the computer 200, the cable 201 and connectors 202, 203. The common interconnect 57 from the common terminal of the piezoelectric actuator 5 is connected to the ground (GND).

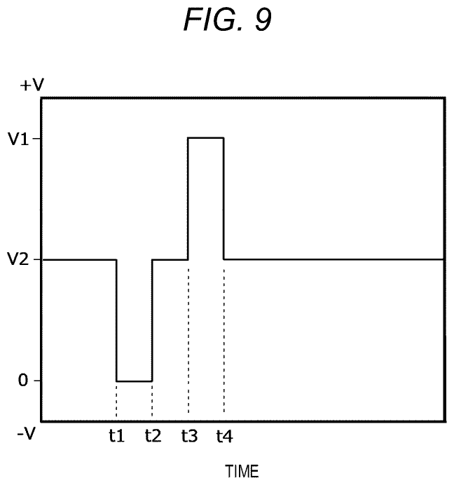

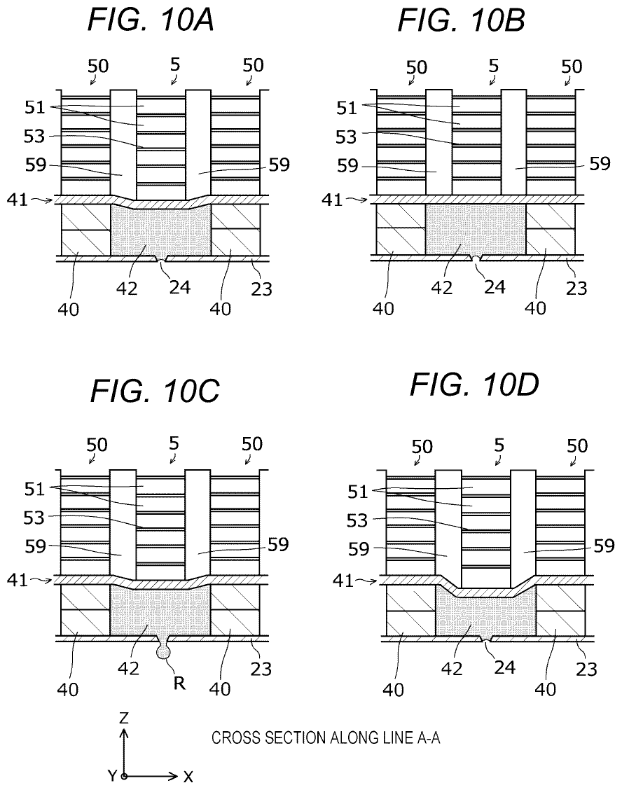

Next, an ink ejection operation will be described with reference to FIGS. 9 and 10. Each drive driver D of the drive IC 3 applies a drive waveform to the individual terminal of the piezoelectric actuator 5 using the drive voltages V1 and V2 and the ground (GND). The voltage V1 is, for example, 20 V. The voltage V2 is, for example, 10 V. The ground (GND) is, for example, 0 V. Which channel's piezoelectric actuator 5 is to be driven is determined based on, for example, print data. FIG. 9 is an example of the drive waveform applied to the piezoelectric actuator 5.

When the piezoelectric actuator 5 in which a ground voltage is applied to the common terminal is to be driven, as shown in FIG. 9, the voltage V2 is applied to the individual terminal to be in a standby state. When the voltage V2 is applied, an electric field is applied in a direction of a polarization axis of the piezoelectric body 51, and as shown in FIG. 10A, due to an inverse piezoelectric effect of the piezoelectric element, the piezoelectric actuator 5 is elongated in a lamination direction (i.e., Z direction) and a volume of the pressure chamber 42 is reduced. The above is performed prior to an ink ejection timing. Thereafter, a potential of the individual terminal is first lowered to the ground (GND) at the ink ejection timing (time t1 in FIG. 9), whereby the elongated piezoelectric actuator 5 returns to an original state, that is, relatively contracts, and the volume of the pressure chamber 42 relatively expands, as shown in FIG. 10B. When the volume of the pressure chamber 42 expands, a meniscus on a boundary surface between the ink in the nozzles 24 and outside air is drawn in a concave shape toward the pressure chamber 42.

Then, for example, when the voltage V2 is applied to the individual terminal at a time t2 in FIG. 9 after ½ of a pressure vibration cycle of the head unit 2 elapses, as shown in FIG. 10C, the piezoelectric actuator 5 is elongated in the lamination direction and the volume of the pressure chamber 42 is relatively reduced, whereby droplets R of ink are ejected from the nozzle 24. Then, for example, after ½ of the pressure vibration cycle of the head unit 2 elapses, the voltage V1 is applied to the individual terminal at a time t3 in FIG. 9, and is returned to the voltage V2 at a time t4 after a predetermined time elapses. The volume of the pressure chamber 42 is reduced and restored by the elongation (FIG. 10D) and restoration (FIG. 10A) of the piezoelectric actuator 5 at this time, and a residual vibration due to this operation is attenuated. In this manner, the volume of the pressure chamber 42 changes in accordance with a longitudinal vibration of the piezoelectric actuator 5 in the lamination direction, and the ink can be ejected. When a series of ejection of the ink is completed, since the volume of the ink in the pressure chamber 42 is reduced by an amount of the ejection, the ink flows into the pressure chambers 42 via the upstream resistance flow paths 43. At this time, when the flow rate of the ink supplied from upstream of the pressure chamber is small, the ink is also drawn into the pressure chamber 42 from downstream via the downstream resistance flow paths 46. When the ink flows into each of the upstream common liquid chamber 44 and the downstream common liquid chamber 47, the damper film of the upstream pressure damper 8 and the damper film of the downstream pressure damper 80 are bent in a direction in which a volume of a damper chamber is reduced, so that the ink is instantaneously supplied to each of the common liquid chambers 44, 47, and then the damper film bent by being replenished with the ink from the upstream ink port 45 returns to an original state.

### Second Embodiment

Next, the ink jet head 100 according to a second embodiment will be described. The ink jet head 100 according to the second embodiment has the same configuration as the ink jet head 100 according to the first embodiment except that the disposition of the pressure dampers 8 and 80 and the bypass resistance flow path 81 is changed. That is, in the first embodiment, both the upstream pressure damper 8 and the downstream pressure damper 80 are disposed in the bypass flow path 49, but the disclosure is not limited thereto.

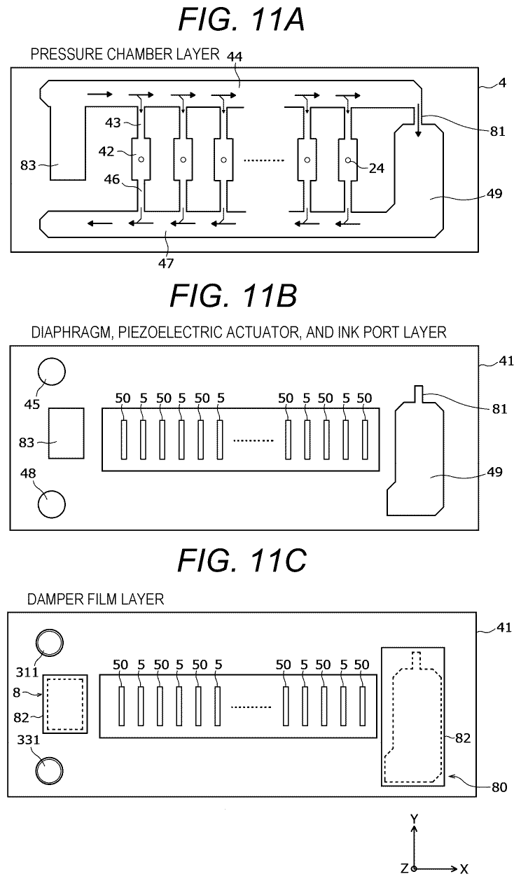

In the ink jet head 100 according to the second embodiment, the downstream pressure damper 80 is provided in the bypass flow path 49, and the upstream pressure damper 8 is provided on a flow path side communicating the upstream ink port 45 and the upstream common liquid chamber 44. As shown in FIGS. 11A to 11C, in the upstream pressure damper 8, a damper chamber 83 communicating with the upstream ink port 45 is formed to extend in a Y direction, and an opening in a Z direction is sealed with the soft material 82 which is a damper film. In the downstream pressure damper 80, the bypass resistance flow path 81 is disposed closer to the upstream common liquid chamber 44, so that most of the bypass flow path 49 serves as the damper chamber, and the opening in the Z direction is sealed with the soft material 82 which is a damper film.

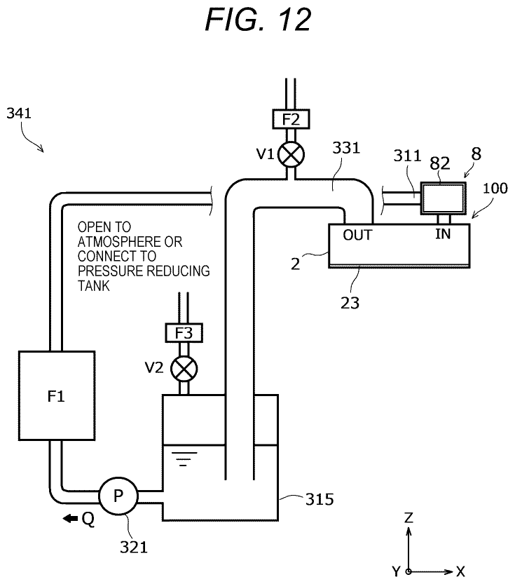

The upstream pressure damper 8 in the second embodiment is expected to have an effect of suppressing a pulsation of the ink pump 321. That is, when a circulation pump (ink pump 321) is disposed upstream of an ink supply path, since the pulsation of the pump is more easily transmitted to an upstream side than to a downstream side, it is desirable to adopt a configuration in which the pressure damper is disposed close to the upstream ink port 45. Although the upstream pressure damper 8 is provided inside the head unit 2 in the present embodiment, the upstream pressure damper 8 may be provided outside and upstream of the upstream ink port 45 (that is, outside the ink jet head 100) separately from the ink jet head 100. FIG. 12 shows an example of the separate upstream pressure damper 8. The upstream pressure damper 8 is disposed in the ink supply path 311. A disposition position is desirably close to the head unit 2. In the upstream pressure damper 8, for example, a rectangular frame-shaped member having an opening on one side or both sides is provided in the middle of the ink supply path 311 to form the damper chamber, and the opening is sealed with the soft material 82 which is a damper film. The ink jet head 100 and the upstream pressure damper 8, which are separate from each other, constitute a liquid ejection device.

### Third Embodiment

Next, the ink jet head 100 according to a third embodiment will be described. The ink jet head 100 according to the third embodiment also has the same configuration as the ink jet head 100 according to the first embodiment except that the disposition of the pressure dampers 8 and 80 and the bypass resistance flow path 81 is changed.

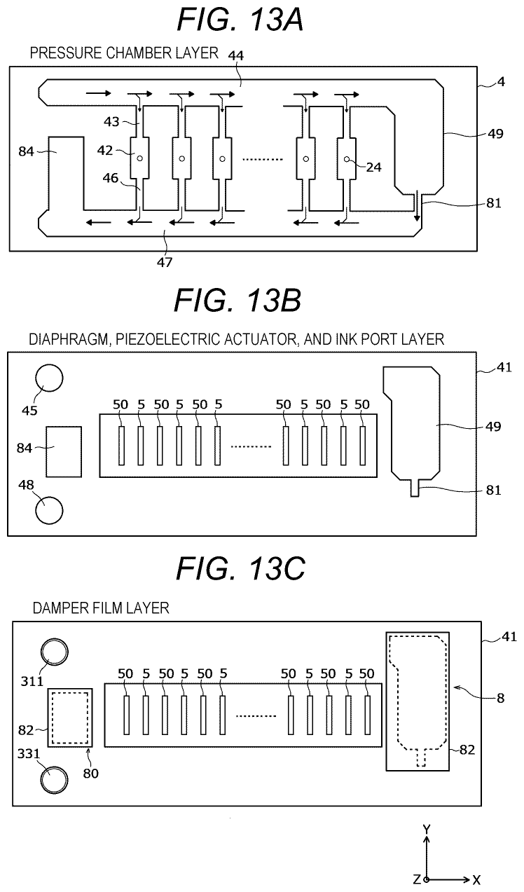

In the ink jet head 100 according to the third embodiment, the upstream pressure damper 8 is provided in the bypass flow path 49, and the downstream pressure damper 80 is provided on a flow path side communicating the downstream ink port 48 and the downstream common liquid chamber 47. As shown in FIGS. 13A to 13C, in the downstream pressure damper 80, a damper chamber 84 communicating with the downstream ink port 48 is formed to extend in a Y direction, and an opening in a Z direction is sealed with the soft material 82 which is a damper film. In the upstream pressure damper 8, the bypass resistance flow path 81 is disposed closer to the downstream common liquid chamber 47, so that most of the bypass flow path 49 serves as the damper chamber, and the opening in the Z direction is sealed with the soft material 82 which is a damper film.

That is, the ink jet head 100 according to the third embodiment has a configuration in which the upstream and the downstream are reverse to those of the ink jet head 100 according to the second embodiment. In such a configuration, when a circulation pump (ink pump 321) is disposed downstream of an ink supply path, an effect of suppressing a pulsation of the pump can be expected. Although the downstream pressure damper 80 is provided inside the head unit 2 in the present embodiment, the downstream pressure damper 80 may be provided outside and downstream of the downstream ink port 48 (that is, outside the ink jet head 100) separately from the ink jet head 100. The downstream pressure damper 80 is disposed in the ink discharge path 331. A disposition position is desirably close to the head unit 2. Similar to the upstream pressure damper 8 shown in FIG. 12, in the downstream pressure damper 80, for example, a rectangular frame-shaped member having an opening on one side or both sides is provided in the middle of the ink discharge path 331 to form the damper chamber, and the opening is sealed with the soft material 82 which is a damper film. The ink jet head 100 and the downstream pressure damper 80, which are separate from each other, constitute a liquid ejection device.

### Fourth Embodiment

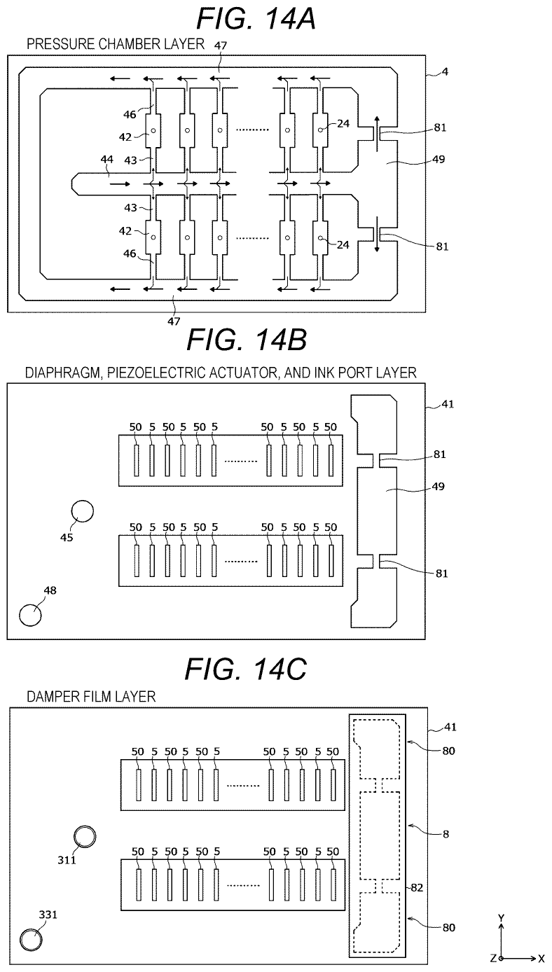

Next, the ink jet head 100 according to a fourth embodiment will be described. As shown in FIGS. 14A to 14C, in the ink jet head 100 according to the fourth embodiment, the pressure chambers 42 are arranged in two rows, and the upstream common liquid chamber 44 is shared between the rows. The upstream pressure damper 8 and the downstream pressure damper 80 are both disposed in the bypass flow path 49, similar to the first embodiment. However, the upstream pressure damper 8 is shared between the rows. With such a configuration, similar to the first embodiment, a damper effect can be applied to both the upstream common liquid chamber 44 and the downstream common liquid chamber 47. Further, there is an advantage that one soft material 82 can be shared by both the upstream pressure damper 8 and the downstream pressure damper 80.

### Fifth Embodiment

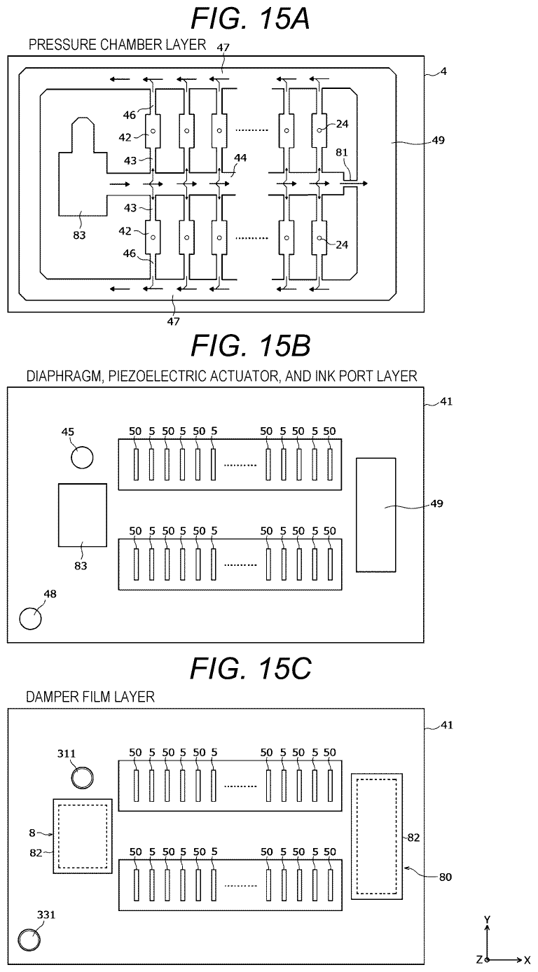

Next, the ink jet head 100 according to a fifth embodiment will be described. The ink jet head 100 according to the fifth embodiment is a modification of the fourth embodiment in which the pressure chambers 42 are arranged in two rows. In the ink jet head 100 according to the fifth embodiment, similar to the second embodiment, the downstream pressure damper 80 is provided in the bypass flow path 49, and the upstream pressure damper 8 is provided on a flow path side communicating the upstream ink port 45 and the upstream common liquid chamber 44. As shown in FIGS. 15A to 15C, in the upstream pressure damper 8, the damper chamber 83 is formed at a connection portion between the upstream ink port 45 and the upstream common liquid chamber 44, and an opening in a Z direction is sealed with the soft material 82 which is a damper film. In the downstream pressure damper 80 shared by the rows, the bypass resistance flow path 81 is disposed near a boundary with the upstream common liquid chamber 44, so that most of the bypass flow path 49 serves as the damper chamber, and the opening in the Z direction is sealed with the soft material 82 which is a damper film. In such a configuration, similar to the second embodiment, when a circulation pump (ink pump 321) is disposed upstream of an ink supply path, an effect of suppressing a pulsation of the pump can be expected. Although the upstream pressure damper 8 is provided inside the head unit 2 in the present embodiment, the upstream pressure damper 8 may be provided outside and upstream of the upstream ink port 45 (that is, outside the ink jet head 100) separately from the ink jet head 100. The separate upstream pressure damper 8 is disposed, for example, in the ink supply path 311 (see FIG. 12). The ink jet head 100 and the upstream pressure damper 8, which are separate from each other, constitute a liquid ejection device.

### Sixth Embodiment

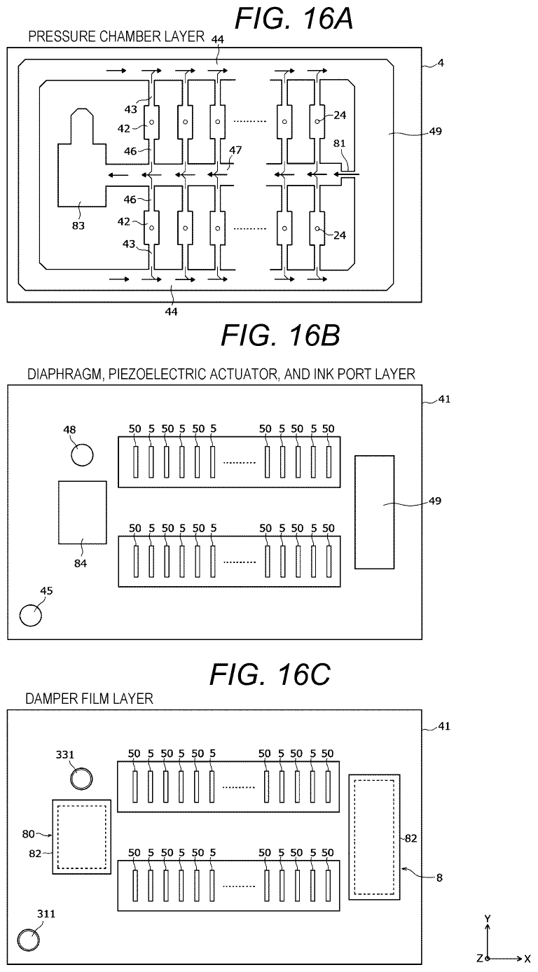

Next, the ink jet head 100 according to a sixth embodiment will be described. The ink jet head 100 according to the sixth embodiment is a modification of the fourth embodiment in which the pressure chambers 42 are arranged in two rows. In the ink jet head 100 according to the sixth embodiment, similar to the third embodiment, the upstream pressure damper 8 is provided in the bypass flow path 49, and the downstream pressure damper 80 is provided on a flow path side communicating the downstream ink port 48 and the downstream common liquid chamber 47. That is, the ink jet head 100 according to the sixth embodiment has a configuration in which the upstream and the downstream are reverse to those of the ink jet head 100 according to the fifth embodiment. As shown in FIGS. 16A to 16C, in the downstream pressure damper 80, the damper chamber 83 is formed at a connection portion between the downstream common liquid chamber 47 and the downstream ink port 48 shared between the rows, and an opening in a Z direction is sealed with the soft material 82 which is a damper film. In the upstream pressure damper 8, the bypass resistance flow path 81 is disposed near a boundary with the downstream common liquid chamber 47, so that most of the bypass flow path 49 serves as the damper chamber, and the opening in the Z direction is sealed with the soft material 82 which is a damper film. The upstream pressure damper 8 is shared between the rows. In such a configuration, similar to the third embodiment, when a circulation pump (ink pump 321) is disposed downstream of an ink supply path, an effect of suppressing a pulsation of the pump can be expected. Although the downstream pressure damper 80 is provided inside the head unit 2 in the present embodiment, the upstream pressure damper 8 may be provided outside and downstream of the downstream ink port 48 (that is, outside the ink jet head 100) separately from the ink jet head 100. The separate downstream pressure damper 80 is disposed, for example, in the ink discharge path 331. The ink jet head 100 and the downstream pressure damper 80, which are separate from each other, constitute a liquid ejection device.

### Seventh Embodiment

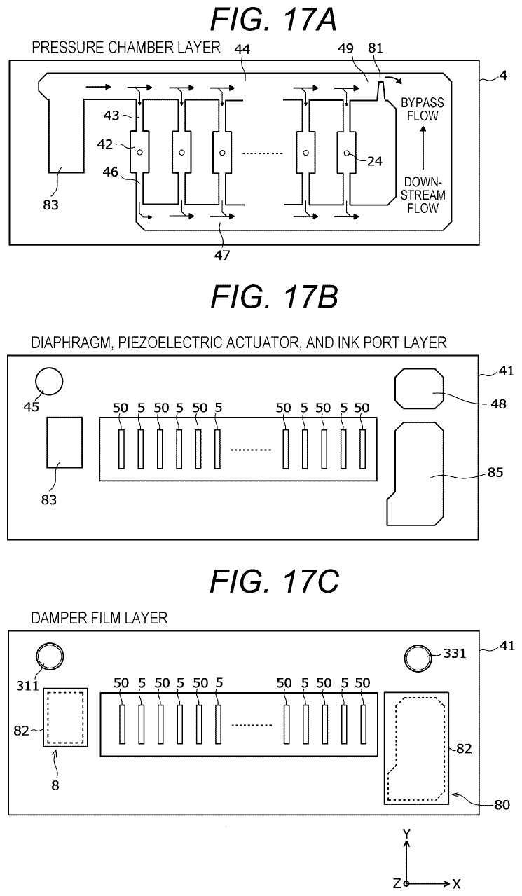

Next, the ink jet head 100 according to a seventh embodiment will be described. The ink jet head 100 according to the seventh embodiment is a modification of the first embodiment. That is, in the ink jet head 100 according to the first embodiment, the other ends of the upstream common liquid chamber 44 and the downstream common liquid chamber 47 are connected by the bypass flow path 49, but the disclosure is not limited thereto. As shown in FIGS. 17A to 17C, the ink jet head 100 according to the seventh embodiment is configured such that the downstream ink port 48 is disposed on one end side of the bypass flow path 49 and a bypass circulation flow passes through only the upstream common liquid chamber 44. In the upstream pressure damper 8, the damper chamber 83 communicating with the upstream ink port 45 is formed to extend in a Y direction, and an opening in a Z direction is sealed with the soft material 82 which is a damper film.

On the other hand, pressure chamber circulation flows supplied from the upstream common liquid chamber 44 to the pressure chambers 42 via the upstream resistance flow paths 43 merge with each other in the downstream common liquid chamber 47, pass through a flow path of a downstream flow in FIGS. 17A to 17C, and are discharged via the downstream ink port 48. The downstream pressure damper 80 is formed by forming a portion of the flow path of the downstream flow as a downstream damper chamber 85 and sealing an opening with the soft material 82 which is a damper film. In this manner, even when the bypass flow and the downstream flow are separate paths, the same effect as that of the above-described embodiments can be obtained by setting a relationship between the bypass resistance flow path 81 and the upstream/downstream pressure dampers 8, 80 in the same manner. Although the upstream pressure damper 8 is provided inside the head unit 2 in the present embodiment, the upstream pressure damper 8 may be provided outside and upstream of the upstream ink port 45 (that is, outside the ink jet head 100) separately from the ink jet head 100. The separate upstream pressure damper 8 is disposed, for example, in the ink supply path 311 (see FIG. 12). The ink jet head 100 and the upstream pressure damper 8, which are separate from each other, constitute a liquid ejection device.

As described above, according to the above-described embodiments, since the bypass flow path 49 connecting the upstream common liquid chamber 44 and the downstream common liquid chamber 47 is provided on the other end side in the arrangement direction of the plurality of pressure chambers 42, the bypass resistance flow path 81 is provided in the bypass flow path 49, and the pressure dampers 8 and 80 are disposed upstream and downstream of the bypass resistance flow path 81, it is possible to stably eject the ink in the ink circulation type head.

Increasing the circulation flow rate of the ink in the entire head unit 2 by providing the bypass flow path 49 has an advantage that the ink easily transfers heat to the head unit 2 and a temperature of the head unit 2 can be brought close to a temperature of the ink. In addition, in order to increase the circulation flow rate of the ink in the entire head unit 2 by providing the bypass flow path 49, it is possible to stir the ink by increasing the circulation flow rate, and there is also an effect of preventing sedimentation of sedimentary ink containing, for example, silica.

As described above, both the upstream pressure damper 8 and the downstream pressure damper 80 may be provided in the head unit 2, or either one of them may be provided separately outside the head unit 2. When both the upstream pressure damper 8 and the downstream pressure damper 80 are provided inside the head unit 2, a response to a rapid change in ink ejection amount is faster than a case where both are provided outside the head unit 2, which is advantageous in stabilizing the printing quality immediately after a sudden change in print content. On the other hand, when either the upstream pressure damper 8 or the downstream pressure damper 80 is provided outside the head unit 2 and is provided separately from the ink jet head 100, even when the ink jet head 100 is miniaturized, it is easy to increase sizes of the pressure dampers 8 and 80 provided separately, which is advantageous in stabilizing the printing quality with respect to a large fluctuation of the print content or an ink supply pressure.

The piezoelectric actuator 5 is not limited to a laminated type in which a plurality of piezoelectric bodies 51 are laminated. The piezoelectric actuator 5 may be a piezoelectric actuator having a single layer. The operation of the actuator when the drive voltage is applied is not limited to the longitudinal vibration. Further, the embodiment is not limited to a drop-on-demand piezoelectric method, and may be applied to a continuous method.

In the above-described embodiments, the ink jet head 100 of the ink jet printer 10 is described as an example of a liquid ejection device, but the liquid ejection device may be a shaping material ejection head of a 3D printer or a sample ejection head of a dispensing device.

The embodiments have been presented by way of example and are not intended to limit the scope of the exemplary embodiments. These novel embodiments can be implemented in various other forms, and various omissions, substitutions, and modifications can be made without departing from the gist of the exemplary embodiments. These embodiments and modifications thereof are included in the scope and the gist of the exemplary embodiments, and are included in a scope of the exemplary embodiments disclosed in the claims and equivalents thereof.

What is claimed is:

1. A liquid ejection head comprising:
a plurality of pressure chambers arranged in a first direction and respectively communicating with nozzles, each pressure chamber capable of storing liquid;
a plurality of pairs of upstream and downstream flow paths, each pair communicating with a corresponding one of the pressure chambers, the upstream flow path of said each pair being connected to a first end of the corresponding pressure chamber, the downstream flow path of said each pair being connected to a second end of the corresponding pressure chamber;
an upstream common chamber communicating with the upstream flow paths;
an upstream port communicating with the upstream common chamber at a first end of the upstream common chamber in the first direction;
a downstream common chamber communicating with the downstream flow paths;
a downstream port communicating with the downstream common chamber;
a bypass flow path connected between, and communicating with, the upstream common chamber at a second end of the upstream common chamber in the first direction and the downstream common chamber;
a bypass resistance flow path that communicates with the bypass flow path, a cross section of the bypass resistance flow path being narrower than a cross section of the bypass flow path; and
one or more pressure dampers including a first damper region located upstream side of the bypass resistance flow path and a second damper region located downstream side of the bypass resistance flow path.

2. The liquid ejection head according to claim 1, wherein
at least one of the first and second damper regions extends along the bypass flow path.

3. The liquid ejection head according to claim 1, wherein
the bypass flow path is divided into at least two regions, which communicate with each other via the bypass resistance flow path,
the first and second damper regions are included in a single pressure damper, and
each of the first and second pressure damper regions extends along a corresponding one of the two regions of the bypass flow path.

4. The liquid ejection head according to claim 1, further comprising:
a damper chamber extending from the upstream port, wherein
the first damper region extends along the damper chamber, and
the second damper region extends along the bypass flow path.

5. The liquid ejection head according to claim 1, wherein
the upstream common chamber is connected to the bypass flow path via the bypass resistance flow path.

6. The liquid ejection head according to claim 1, further comprising:
a damper chamber extending from the downstream port, wherein
the first damper region extends along the bypass flow path, and
the second damper region extends along the damper chamber.

7. The liquid ejection head according to claim 1, wherein
the downstream common chamber is connected to the bypass flow path via the bypass resistance flow path.

8. The liquid ejection head according to claim 1, wherein
a circulation flow rate of the liquid is greater than or equal to a maximum total ejection flow rate of the liquid ejected from the nozzles,
the circulation flow rate is a flow rate at which the liquid flowing through the upstream flow paths to the downstream flow paths when a flow rate of the liquid entering from the upstream port is substantially equal to a flow rate of the liquid exiting through the downstream port, and
the maximum total ejection flow rate is a flow rate at a full duty with all nozzles ejecting.

9. The liquid ejection head according to claim 1, wherein
at least one of the pressure dampers is membrane dampers formed of a flexible resin.

10. The liquid ejection head according to claim 9, wherein
the one or more pressure dampers are in the bypass flow path.

11. The liquid ejection head according to claim 1, wherein
the pressure chambers are arranged in two rows,
the upstream common chamber extends between the two rows of the pressure chambers,
the downstream common chamber includes a first portion that extends along one of the two rows of the pressure chambers and a second portion that extends along the other row, and
at least one of the first and second damper regions extend along the bypass flow path.

12. The liquid ejection head according to claim 11, further comprising:
a damper chamber extending from the upstream port, wherein
the first damper region extends along the damper chamber.

13. The liquid ejection head according to claim 1, wherein
the pressure chambers are arranged in two rows,
the downstream common chamber extends between the two rows of the pressure chambers,
the upstream common chamber includes a first portion that extends along one of the two rows of the pressure chambers and a second portion that extends along the other row, and
the first pressure damper region extends along the bypass flow path.

14. The liquid ejection head according to claim 13, further comprising:
a damper chamber extending from the downstream port, wherein
the second damper region extends along the damper chamber.

15. The liquid ejection head according to claim 1, further comprising:
a damper chamber extending from the upstream port, wherein
the upstream common chamber is connected to the bypass flow path and the downstream port via the bypass resistance flow path at the second end of the upstream common chamber,
the first damper region extends along the damper chamber, and
the second damper region extends along the bypass flow path.

16. A liquid ejection device comprising:
a tank for storing liquid;
a pump for transferring the liquid from the tank;
a liquid supply path through which the liquid is supplied from the pump;
a plurality of pressure chambers arranged in a first direction and respectively communicating with nozzles, each pressure chamber capable of storing liquid;
a plurality of pairs of upstream and downstream flow paths, each pair communicating with a corresponding one of the pressure chambers, the upstream flow path of said each pair being connected to a first end of the corresponding pressure chamber, the downstream flow path of said each pair being connected to a second end of the corresponding pressure chamber;
an upstream common chamber communicating with the upstream flow paths;
an upstream port communicating with the liquid supply path, the upstream port further communicating with the upstream common chamber at a first end of the upstream common chamber in the first direction;
a downstream common chamber communicating with the downstream flow paths;
a downstream port communicating with the downstream common chamber;
a bypass flow path connected between, and communicating with, the upstream common chamber at a second end of the upstream common chamber in the first direction and the downstream common chamber;
a bypass resistance flow path that communicates with the bypass flow path, a cross section of the bypass resistance flow path being narrower than a cross section of the bypass flow path; and
one or more pressure dampers including a first damper region located upstream side of the bypass resistance flow path and a second damper region located downstream side of the bypass resistance flow path.

17. The liquid ejection device according to claim 16, wherein
the pressure chambers, the upstream and downstream flow paths, the upstream and downstream common chambers, the upstream and downstream ports, the bypass flow path, the bypass resistance flow path, and one of the one or more pressure dampers form a liquid ejection head that is connected to the liquid supply path and configured to eject the liquid, and
another one of the one or more pressure dampers is outside the liquid ejection head.

18. The liquid ejection device according to claim 16, wherein
the pressure chambers, the upstream and downstream flow paths, the upstream and downstream common chambers, the upstream and downstream ports, the bypass flow path, the bypass resistance flow path, and the one or more pressure dampers form a liquid ejection head that is connected to the liquid supply path and configured to eject the liquid.

19. The liquid ejection device according to claim 16, wherein
a circulation flow rate of the liquid is greater than or equal to a maximum total ejection flow rate of the liquid ejected from the nozzles,
the circulation flow rate is a flow rate at which the liquid flowing through the upstream flow paths to the downstream flow paths when a flow rate of the liquid entering from the upstream port is substantially equal to a flow rate of the liquid exiting through the downstream port, and
the maximum total ejection flow rate is a flow rate at a full duty with all nozzles ejecting.

20. An image forming apparatus comprising:
an ink jet head; and
a control board configured to control the ink jet head, wherein
the ink jet head includes:
a plurality of pressure chambers arranged in a first direction and respectively communicating with nozzles, each pressure chamber capable of storing liquid,
a plurality of pairs of upstream and downstream flow paths, each pair communicating with a corresponding one of the pressure chambers, the upstream flow path of said each pair being connected to a first end of the corresponding pressure chamber, the downstream flow path of said each pair being connected to a second end of the corresponding pressure chamber,
an upstream common chamber communicating with the upstream flow paths,
an upstream port communicating with the upstream common chamber at a first end of the upstream common chamber in the first direction, a downstream common chamber communicating with the downstream flow paths,
a downstream port communicating with the downstream common chamber,
a bypass flow path connected between, and communicating with, the upstream common chamber at a second end of the upstream common chamber in the first direction and the downstream common chamber,
a bypass resistance flow path that communicates with the bypass flow path, a cross section of the bypass resistance flow path being narrower than a cross section of the bypass flow path, and
one or more pressure dampers including a first damper region located upstream side of the bypass resistance flow path and a second damper region located downstream side of the bypass resistance flow path.
